(19) United States
(12) Patent Application Publication
(10) Pub. No.: US 2014/0172535 A1
(43) Pub. Date: Jun. 19, 2014

(54) LOYALTY SYSTEMS AND METHODS

(71) Applicant: Susan Matthews, Camp Hill (AU)

(72) Inventor: Susan Matthews, Camp Hill (AU)

(21) Appl. No.: 14/237,222

(22) PCT Filed: Jul. 5, 2012
(86) PCT No.: PCT/AU2012/000813

§ 371 Date: Feb. 5, 2014

Related U.S. Application Data
(60) Provisional application No. 61/504,310, filed on Jul. 5, 2011.

(51) Int. Cl. G06Q 30/02

(52) U.S. Cl. CPC G06Q 30/0226
USPC 705/14.27

(57) ABSTRACT

A loyalty system and/or method comprising a mobile computing device and a server wherein the mobile computing device communicates with the server to obtain a loyalty code for use in a loyalty program.

### BACKGROUND TO THE INVENTION

Membership/loyalty/reward programs traditionally are on business/organization to business/organization bases, i.e. each business/organization has its own individual membership/loyalty/rewards program. The few programs that are available for multi businesses/organizations only can have businesses/organizations that are related. Currently there is no membership/loyalty/rewards program that is for unrelated businesses/organizations. Traditionally people would receive from a business a Paper card 10 from a business as a membership/loyalty/reward card for each business membership/loyalty/reward program that they joined either directly or indirectly. In some cases PVC plastic cards are issued instead of Paper Cards. This system has a bt of problems associated with it such as:

People often receive a different card for each membership/loyalty/reward card for every business membership/loyalty/reward program that they join either directly or indirectly. These cards can either be made of PVC or Paper material. Paper cards often have a spot for either a punch mark to be made, a signature by the shop attendant or stamp or some other mark. By joining different membership/loyalty/reward programs and being given a card to carry for each membership/loyalty/reward program after a short number of cards it often causes difficulty in physically carrying around all the membership/loyalty/rewards cards. This is particularly true for Coffee Loyalty cards. Most people don't like having to carry around all of the cards that they receive from places that they visit because it is not convent and trying to find the right loyalty card for the business that they want to make a purchase at is also inconvenient.

Membership/loyalty/rewards is an added cost for businesses, to constantly supply loyalty cards to their customers, when one membership/loyalty/rewards card fills up, then a new one has to be provided to the customer. Businesses often complain that a single customer can have multi membership/loyalty/rewards cards on the go at once as they fail to remember to bring the membership/loyalty/rewards card and therefore have to be supplied with a new rewards card. The cost of membership/loyalty/rewards cards is often not recouped directly by the business as there is not a culture of charging for the loyalty cards.

In addition, due to the costs. It is often unaffordable to small business to pay and implement a membership/loyalty/rewards program as it would require a programmer to make changes to their existing system. If the business wanted to join an existing rewards program, often they would need a very high sales turnover as well as a large amount of capital for the marketing and advertising. This often puts it out of reach for most small businesses. It is not affordable or practical to the majority of businesses.

Current cards cart either be made of PVC or Paper material. Paper cards often have a spot for either a punch mark to be made, a signature by the shop attendant or stamp or some other mark. Paper cards are often damaged easily.

Currently with membership cards/loyalty cards that are handed over the counter there is no way of capturing the user information to allow the business to market to their customer group at a later date. This is particularly true in the case of coffee shops, currently a loyalty card is just handed out to the person purchasing the coffee, typically the coffee loyalty card has ten places in which a stamp may be placed. Alternatively a staff member signs the card or a hole is punched by the coffee shop employees that indicate the number of coffees purchased. Without capturing of this data, it makes it very difficult for a business to target market to its customers. It also makes it difficult to track the frequency of the use by the user of the product or service, thus making it difficult for businesses to plan.

The process can be time consuming and also upset customers if there is a large number of people queuing for coffee, as the wait for the customer to produce the loyalty card and then having the card either stamped; signed or punched by the shop attendant seems longer than the process is by the customer as they wait in line with time pressures on them. Often this process can result in lost business as the customers gets frustrated waiting. Alternatively people don't take loyalty cards and as a direct result miss out on loyalty rewards that they can earn.

Customers can become frustrated if they do not have their card when they make a purchase, this often causes the customer to feel dissatisfied and even upset with the company. If the business then stores cards for the customer, this then impacts on customer wait times and staff time to find the card, mark off the card and then to re-file the card. A further problem with this approach is the issue of storing all the customers cards with easy access in often a limited space environment.

The constant use and need to replace paper based cards require environmental resources, such as trees being chopped down and the carbon produced in the production of the paper. The ability to have PVC based card which currently does only one business means that the production increases as businesses want to provide their customers with PVC based cards. In the current times the consumer is more environmentally friendly than ever and is often looking for ways to reduce the impact on the environment.

The reference to any prior art in this specification is not, and should not be taken as, an acknowledgement or any form of suggestion that the prior art forms part of the common general knowledge.

### SUMMARY OF THE INVENTION

According to one aspect of the invention, there is provided a system for providing a loyalty reward program comprising a processor to process loyalty program information and a data store to store loyalty program information wherein the system is able to receive instructions directly or indirectly from at least one mobile computing device in order to receive an instruction from a user in relation to the loyalty program, the instruction being operable by the processor to take a step in relation to the loyalty program and wherein the instruction may optionally comprise one or more of (i) adding a user to a database and (ii) recording data in the data store.

The invention also provides a loyalty system comprising a mobile computing device and a server wherein the mobile computing device communicates with the server to obtain a loyalty code for use in a loyalty program.

In another aspect, there is provided a method for providing a loyalty reward program comprising the steps of (a) providing an interface for receiving one or more instructions in relation to a loyalty program, (b) receiving via a network an instruction in relation to a loyalty program, (c) processing the instruction using a processor, and (d) following the instruction(s) which may optionally comprise one or more of (i) adding a user to a database, (ii) recording a loyalty reward event in a data store, and (iii) enable redemption of a loyalty reward.

The invention also provides a method for providing a loyalty system comprising a mobile computing device and a server wherein the mobile computing device communicates with the server to obtain a loyalty code for use in a loyalty program.

In one aspect there is provided a set of instructions in a machine readable language which are downloadable from a central store onto the mobile computing device and which are for facilitating the use of one or more loyalty codes.

The system may comprise a data store to store and aggregate data relating to purchasing and other behaviors of users of the loyalty scheme. The method may comprise the steps of aggregating data relating to purchasing and other behaviours of users of the loyalty scheme.

The system may comprise a single loyalty code may be used across a plurality of unrelated locations. The method may comprise the step of using a single loyalty code may be used across a plurality of unrelated locations.

The system may also comprise a data store to store information relating to a plurality of loyalty programs and an interface to enable a user to search and/or browse information about the one or more loyalty programs and optionally select one or more loyalty programs to join. The method may also comprise the steps of storing in a data store information relating to a plurality of loyalty programs and displaying to a user information about the one or more loyalty programs and optionally enabling a user to select one or more loyalty programs to join.

In one aspect of the invention, there is provided a loyalty system and/or method comprising a mobile computing device and a server wherein the mobile computing device communicates with the server to obtain a loyalty code for use in a loyalty program. In some embodiments, the invention comprises a set of instructions in a machine readable language which are downloadable from a central store onto the mobile computing device and which are for facilitating the use of such codes. In some embodiments, the central store comprises an online mobile application store, such as the Android or Itunes App store, in some embodiments, the mobile computing device communicates with the server to download the set of instructions, while in some embodiments, this may also be effected via another computing device.

In another aspect of the invention, there is provided a loyalty system and/or method comprising a mobile computing device and a server wherein the mobile computing device communicates with the server to enable registration of a user and thereby collection of a loyalty code created for that user. Communication may be by any suitable means it may be electronic, it may be wireless, it may be plug-in, it may be via sms or phone call, VOIP, etc. In some aspects of the invention, such communication may be via manual entry of a form of or a proxy for the loyalty code into a location on a computer or computer network, such as a web page, for example when using an online store.

A loyalty code according to the invention may take any suitable form. It may be electronic, it may be printable, it may be a barcode, it may be a pattern, a QR code or any other suitable identifying code.

In one aspect of the invention, there is provided a loyalty system and/or method comprising a mobile computing device and a communication means to communicate with the mobile computing device wherein a user may cause the mobile device to communicate with the communication means and thereby utilize a loyalty code according to the invention. Such utilization may be for any suitable means, for example to collect loyalty points in respect of an action, such as being present at a location, or making a purchase, or to redeem points, etc.

In some embodiments of the invention, the loyalty code may be used in respect of loyalty schemes across a plurality of businesses, whether related or not. In some embodiments, the overall loyalty system is configurable by a loyalty scheme provider to allow one or more businesses or other organizations to participate and to configure such aspects as the degree and type of participation (for example, by placing limits as to geographical reach, type of goods or services that earn points or for which points can be redeemed, etc.).

In some aspects of the invention there is provided a data store to store and aggregate data about the purchasing and other behaviours of users of the loyalty scheme. In some aspects, such a data store aggregates data about the businesses or organizations and/or their customers/members. Such aspects have particular utility in analyzing marketing related information and offering targeted promotions, or other specialist services.

In some embodiments, the mobile device may be used to make the purchase itself as well as to collect loyalty points associated with the loyalty code.

In some aspects, the system and method of the invention allows for a single membership loyalty/rewards card that will enable a user to use this in multi locations and unrelated businesses/organizations. As well as the option for a smart phone application that works in place of the physical card, by allowing the phone to interact with the reward program in the format interaction in the way of a barcode or other form such as radio frequency band width on the phone being able to be scanned at the point of ordering/purchase as more people use and carry smart phones than ever before. Such a system allows businesses to target market their audience more accurately; to allow the process of dealing with loyalty points, including for the customer to see the loyalty points for each business of which they are a customer of.

In one aspect of the invention, there is software system that operates on smart phones, over the internet or in a local environment that allows the end user to be part of membership/loyalty/rewards programs by unrelated/related business entitles and organizations. In another aspect of the invention there may or may not be a physical card/printout containing information.

In some embodiments of the invention, the system and method comprises use of a single loyalty code across a plurality of outlets. The outlets may be of any suitable type in which a loyalty code is useful, for example physical shops or virtual or online shops or other businesses, clubs, schools, government services, etc.

In some aspects, the invention provides an interface through which a user may select one or more additional loyalty programs to participate in. The system and method of the invention may provide a list stored on a local store, or selection of an option by the user may prompt a search for one or more further loyalty programs which fit one or more criteria. The search may be in a database on a data storage means (such as on a server associated with a system and method of the invention), or it may be on a network of computers, such as the internet.

In some embodiments, the user may be alerted to loyalty programs of interest to that user (for example those which fit one or more preselected criteria). The user may also search, browse or use any other suitable method to identify loyalty programs of interest. In some embodiments, the user may be alerted to or identified (eg. through search) one or more loyalty programs due to one or more social media mechanisms. This may be for any suitable reason, for example because one or more of a user's connections (such as friends or family) are participating in or have shown interest in the loyalty program, or because it is mentioned by a connection, or because other people with one or more similar characteristics have elected to join the loyalty program or shown interest in it etc. Preferably the interface optionally enables the user to join the one or more selected loyalty programs. This may done in any suitable way, for example, the system of the invention may access the API of a system associated with the loyalty program and thereby provide certain data and thereby register the user to that loyalty program. Equally, the system of the invention may simply cause to be displayed a page on a website associated with the loyalty program, or send a message (by sms, email, etc.) eg. to the loyalty program provider or to the user in relation to the loyalty program. Preferably the mechanism for joining an additional loyalty program is quick and simple for the user. For example, it may rely on data previously entered by the user or gathered by the System and Method of the invention in relation to that User in order to apply to join and/or register for the additional loyalty program. In some embodiments, the system and method of the invention allows a single loyalty code to be used for more than one loyalty program.

Embodiments of the invention which comprise the ability to identify and/or sign up to additional loyalty programs allow users to know about other rewards programs and in some embodiments, quickly and easily join them. Once joined the invention may allow a user to have all rewards programs organised in the one place without having to organise those various loyalty programs into folders or other organisational means. This aspect of the invention may in some embodiments, work by using a code to identify the program (i.e. program id code) and then link through to the other rewards program.

In some aspects of the invention loyalty points may be transferred between any two parties, irrespective of any relationship between them. Thus, for example allows the user to transfer points to their best friend to allow their best friend to have a free coffee as well as them. This can be used in any situation where loyalty/reward systems are in place. Transfer may occur by any suitable means, for example, by a simple transfer notification by email, sms, to the recipient or by clicking a button on a web interface.

In some embodiments, loyalty points may be given as a gift to another person. Thus for example, this would allow the user to gift points to their best friend to allow their best friend to take advantage of the earned loyalty rewards, such as for a special occasion. In some embodiment, the system and method of the invention enables a message such as a video message; e-mail; sms; mms or other to be sent with the gift of reward points.

In some embodiments, the system and method of the invention enables a user to loan one or more loyalty points to another person. Such points may be provided free of interest, or Interest or some other payment may be required. The system and method of the invention in these embodiments provides an interface for entering the users choices in relation to the person who will be provided with the loan, and terms such as interest etc. In some embodiments, the system and method of the invention provides a user with the ability to request a loan. Such a loan request may be done in any suitable way, for example to a body of users who have agreed to loan points, or to a specific person, etc. In some embodiments, a friend may wish to lend points but wants them returned. This would allow an agreement between the two parties to lend the points and then to have those points paid back when the user who borrowed the points next earns points then they would be automatically assigned to the user who lent the points. Such embodiments solve a common issue for example where a user wishes to purchase something for their children via the rewards program however is for example 5,000 points short.

In some aspects of the invention the system and method enables a user to swap, trade or purchase loyalty rewards within a market place. As an example, sometimes people accumulate points at a particular business but don't like the rewards offered in return and if those people have the opportunity to swap; trade or purchase points then they may be able to have a reward that they want from a different rewards program. In some examples, people may use such a system in order to plan events.

In some embodiments, the system and method of the invention provides a reward system for a government service such as a transport system or other. In some embodiments the government service allows rewards built up from one or other programs to be redeemed for that particular government service. As an example in relation to the transport system, such an embodiment provides the ability to use a loyalty code and phone id for transport systems rather than having to carry a transport card. Similarly, by providing a reward system according to the invention for a government service such as a transport system, users may be able to build up points and thereafter travel free from time to time. Preferably such embodiments are utilised on a mobile computing device.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

FIG. 1 shows a plan/flowchart view of G4C System in accordance with an embodiment of the present invention. In FIG. 1, the G4C System shown is not to scale.

FIG. 2 shows another plan/flowchart view of G4C System in accordance with an embodiment of the present invention. In FIG. 2, the G4C System shown is not to scale.

FIG. 3 shows another plan/flowchart view of G4C System in accordance with an embodiment of the present invention, in FIG. 3, the G4C System shown is not to scale.

FIG. 4 shows another plan/flowchart view of G4C System in accordance with an embodiment of the present invention. In FIG. 4, the G4C System shown is not to scale.

FIG. 5 shows another plan/flowchart view of G4C System in accordance with an embodiment of the present invention. In FIG. 5, the G4C System shown is not to scale.

FIG. 6 shows another plan/flowchart view of G4C System in accordance with an embodiment of the present invention. In FIG. 6, the G4C System shown is not to scale.

FIG. 7 shows another plan/flowchart view of G4C System in accordance with an embodiment of the present invention. In FIG. 7, the G4C System shown is not to scale.

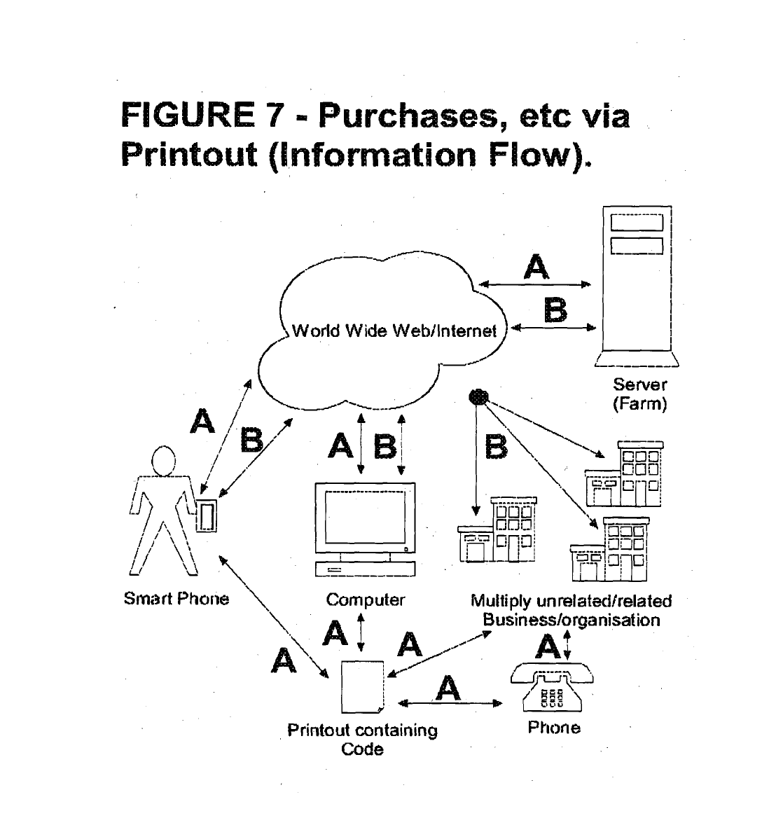

FIG. 8 shows another plan/flowchart view of G4C System in accordance with an embodiment of the present invention. In FIG. 8, the G4C System shown is not to scale.

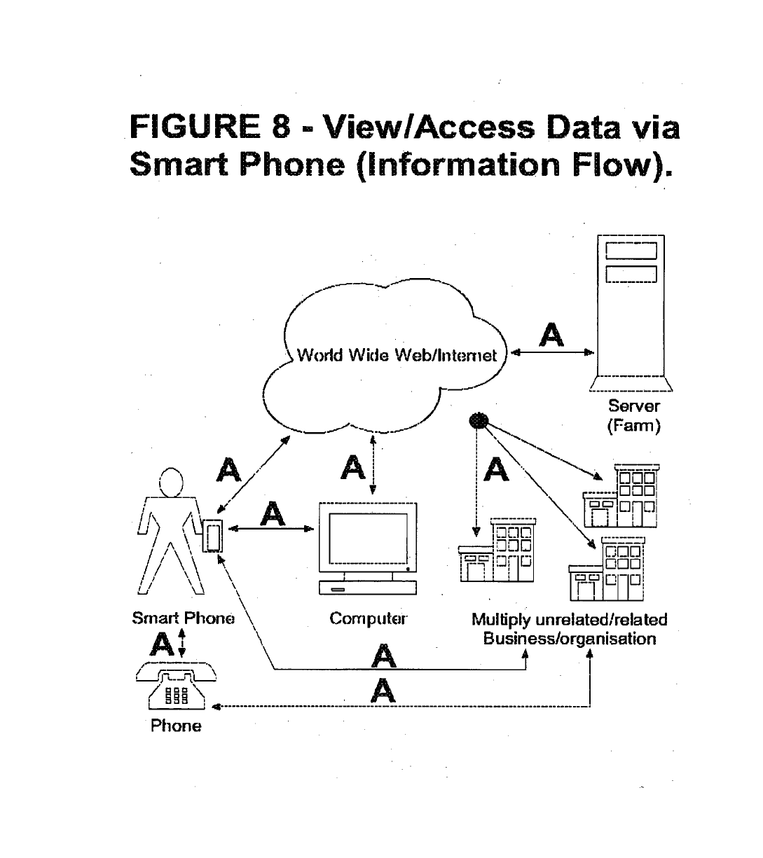

FIG. 9 shows another plan/flowchart view of G4C System in accordance with an embodiment of the present invention. In FIG. 9, the G4C System shown is not to scale.

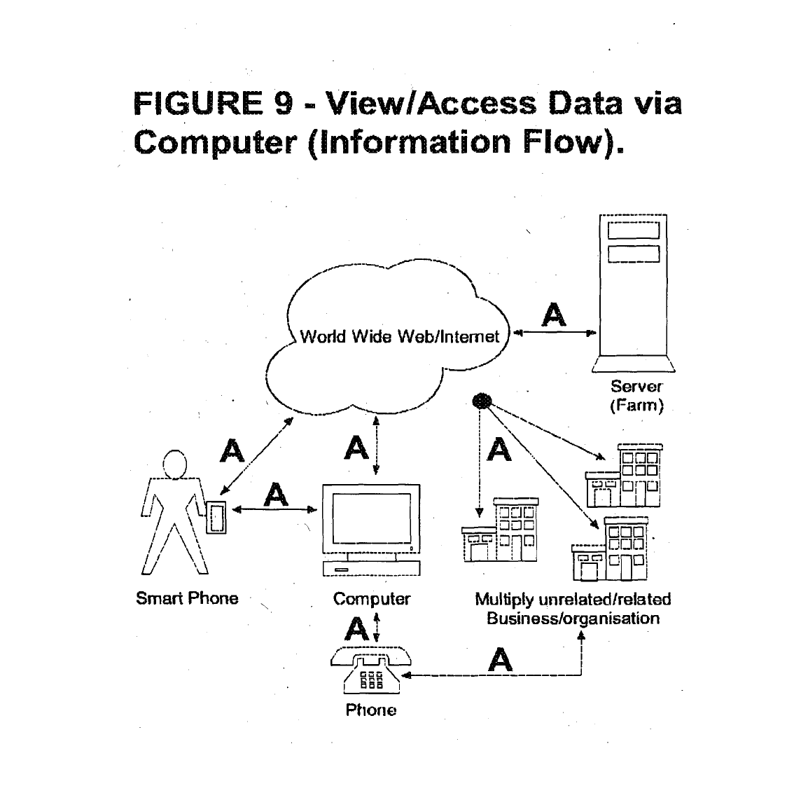

FIG. 10 shows another plan/flowchart view of G4C System in accordance with an embodiment of the present invention, in FIG. 10, the G4C System shown is not to scale.

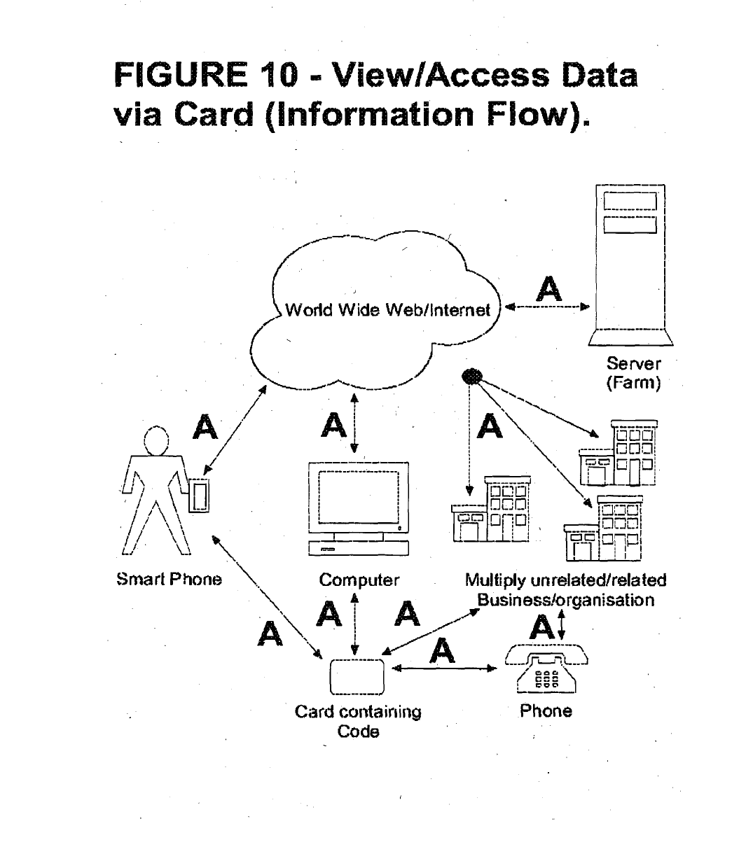

FIG. 11 shows another plan/flowchart view of G4C System in accordance with an embodiment of the present invention. In FIG. 11, the G4C System shown is not to scale.

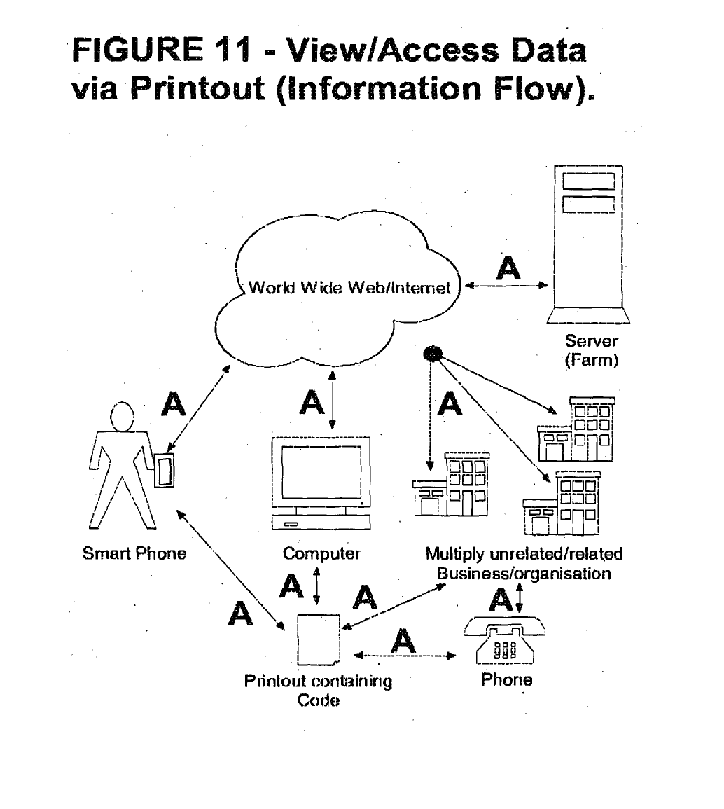

### DETAILED DESCRIPTION OF EXEMPLARY EMBODIMENTS

It is convenient to describe the invention herein in relation to particularly preferred embodiments. However, the invention is applicable to a wide range of industries and it is to be appreciated that other constructions and arrangements are also considered as falling within the scope of the invention. Various modifications, alterations, variations and or additions to the construction and arrangements described herein are also considered as falling within the ambit and scope of the present invention.

It will be understood that the drawings accompanying the specification have been provided for the purposes of illustrating preferred embodiments of the present invention. Therefore, it will be appreciated that the present invention should not be considered to be restricted solely to the features as shown and described in the attached drawings.

### For End Users/Customers

Registration & Control over which membership/loyalty/rewards programs are joined.

### Registration Via Card:

Some embodiments of the invention may comprise of a physical card equipped with barcode/QR code/code technology that allows the user to register their details upon purchase/receipt of the card. This provides advantages including:
the ability for multi unrelated business to have access to the same details such as bar code, end user/customer details,
the ability for the end user/customer to have control over which multiply unrelated/related business/organizations gets access to that information
it also gives the end user/customer the option of which businesses/organizations to have the card linked to, for example the end user/customer might like company A; company B; company C but does not like company D and therefore would not purchase from that business.
Alternatively the end user/customer might require the services of company A; company B; company C; company D but does not require the services of company E. The end user/customer will have the ability to register his or her details with multi companies of his/her choosing. At any stage these changes can be made by the end user/customer; for example as they are going to get married they may elect to have bridal companies added, or if they are going to start a family then they may elect to have baby and children companies added to their list of companies that have their bar code. The control remains with the end user/customer as to which companies have access to their details and bar code. This control can be changed on the fly, for example if an end user/customer walks into a shop and decides that they want to purchase from the shop and join the membership/loyalty/rewards program, then they could simply swipe their card containing the barcode; allow the phone barcode/QR code be scanned; either at the shop or by selecting the option on their smart phone to allow the business/organization to have access to the information as the information will be real time online, i.e. have the option to join the membership/loyalty/rewards program then and there. That way they could make their purchase whilst being a member of the membership/loyalty/rewards programs, and reap the benefit of that purchase being entitled to a discount/earn points/earn reward dollars, etc.

### Registration by Smart Phone App:

Some embodiments of the invention allow the end user/customer to register in the G4C system by smart phone or computer system. The end user/customer once they have registered the G4U will create a unique barcode/QR code/code and directly issue with a barcode/QR Code/code to the smart phone or have the ability to print out a paper card equipped with barcode/QR Code/code. As in above the end user/customer will have the options to select which business/organization membership/loyalty/rewards program that they will join and which business/organizations have access to their information, the access to the end user/customer is controlled by the end user/customer via their smart phone and/or computer system.

### Personalized/Target Marketing—Location and Time Based Marketing.

In some preferred embodiments of the invention the data collection by the system will enable the business/organization to target market to their customer base. It will allow the business to target coupons to individual end users/customer or to a group of end users/customers, for example if the business has a end user/customer who only purchases one type of coffee such as French Vanilla, then the business can send a coupon/discount/advertisement to the customer telling the customer that the French Vanilla Coffee Bean is 25% off. The G4C technology system gives the benefit of target marketing to the individual end user/customer in a way that has not been done previously. It also allows for location target marketing, for example if a person was within a certain distance of a business then the system could advise the end user/customer of the personalized specials for that end user/customer. Location Marketing and/or time based marketing, for example if the end user/customer has lunch between 12 pm to 1 pm then time based marketing could kick in. If the end user/customer works in a large office block and does not really move out of that location i.e. move more than 1 kilometer/mile then time based marketing would allow business/organizations local to that location to personalized target market for times such as lunch time, morning and afternoon tea breaks. This also comes into play for delivery, for those businesses offering delivery between certain times, target marketing would allow those businesses to be to transact with the end user/customer when the delivery van is in a certain area at certain times. The end user/customer would have the control over which businesses/organizations that could or could not target market to them and the frequency of the marketing. From a business/organization prospective it reduces the risk of low returns on advertising as the advertising is personalized for the end user. People switch off to advertising because they are often not interested in the product or the service is not relevant to their life style. If the end user/customer is target marketed with a personalized marketing campaign (i.e. in products and services which they currently used or are likely to use) then the end user/customer is more likely to take notice of what is being offered by the business/organization in the marketing campaign. Marketing could be by sms; e-mail; coupons; discounts; specials; quantity buys, reward/loyalty dollars etc. Marketing by the system would be sent to the person's computer and/or smart phone. The marketing offers would be able tote viewed by the end user/customer via their smart phone.

Immediate Access to View Membership/Loyalty/Reward Units and being Able to View Transactions Making Up Those Units

In an embodiment of the invention the end user/customer would be able to view their membership/loyalty/rewards units to see if they had reached the required number of units (such as points or dollars) via their smart phone, i.e. they will have access to the amount of units earned and then be able to drill down and see the purchases that resulted in those units being earned. The G4C system would also allow the end user/customer to view the purchases that they had made for the business/organization or they could collectively view all transactions. Traditionally users are only able to log on to rewards programs using a computer which the user has to go to a specific website for an individual business or related group of businesses; wait for a user statement to be posted to them usually at a month or 3 monthly duration; phone the company to see how many rewards/loyalty units have been collected; look at the paper based card to see how many items have been either marked off or punched. None of the information is available by smart phone app whereby you can immediately see the units earned to date and the purchases made that resulted in those units being earn. The G4C System will also give the end user/customer customization facilities where by the could have the information show in a specific format, for example the end user/customer may choose to display the units earned by location; by date; by greatest units earned, etc. The G4C System can also allow customization by favorites list; ability to group business/organizations together, for example coffee shops; clothing shops, etc.

### Shop Online—

In an embodiment of the invention the G4C system will have the ability to enable the end user/customer to go shopping online with the business/organizations where the end user/customer details will automatically populate into the shopping cart when a purchase is made. For example the membership/loyalty/rewards barcode/QR code will automatically come across rather than the end user/customer having to enter in that information into the website of the business/organization that they, are purchasing from. The current system is that the end user/customer needs to manually enter in a membership/loyalty/rewards code. The G4C system will given the end user/customer the ability to see all discounts/coupons for the business/organization website that they are currently shopping on and will also have the ability to automatically apply the discount/coupons, etc to the shopping cart without having to manually enter the coupon, discount code information in. The G4C system removes the need for the customer having to remember a code or having to have the code at their fingertips when shopping online.

### Security—

In an embodiment of the invention the G4C system would have the ability to be able to associate MAC addresses to barcodes/QR codes for security purposes.

In an embodiment of the invention the G4C system may have password protection and may or may not include a series of questions for the purposes of identifying the end user/customer/business/organization accessing the G4C System.

In an embodiment of the invention the barcode/OR code will contain information unique to the end user/customer.

In an embodiment of the invention a pin code may or may not be used as password protection.

### Confirmation of Purchase—

In an embodiment of the invention the business/organization has the ability to automatically sms; email; provide web access to a receipt/confirmation of purchase. From the end user/customer the ability to be able to receive a receipt/confirmation of purchase reduces the need to provide a paper receipt of purchase. Being able to automate this system, saves staff time by staff not having to change paper roles in machine; save time for the end user/customer by them not having to scan in a receipt or photograph the receipt if it is required for tax purposes as most receipts will fade if exposed to the sun or high temps. It also saves the environment by reducing the number of trees having to be cut down to make paper and also limits carbon emissions by the manufacturing process of making paper.

### Rewards Scale—

In an embodiment of the invention, the end user/customer can view what the rewards scale is for each business and how the units are calculated. This leads to a better informed consumer and transparency in business. Under the current system of a paper based card, the end user/customer can see the number of units (for example coffees) that they must get before achieving the reward such as a free cup of coffee. However some businesses in this industry may include all drinks in this system not just coffee, where as other businesses only include coffee and not other drinks such as hot chocolates, etc. Currently with other rewards programs they are not clearly defined on the rewards scale or the information is not available at the fingertips of the end user/customer. This can lead to confusions amongst the end user/customer. Under the G4C System using the smart phone or computer or other applicable electronic device the user is able to clearly view the reward scales of the business/organization. The information is available at the fingertips of the end user/customer.

### Exchange Rates & Multi Locations, Portability—

In an embodiment of the invention the G4C System allows the end user/customer to make purchases in multi locations including multi countries. The G4C system will display the purchases made in two currencies, the end user/customer's preferred currency and the actual countries currency where the transaction took place. The G4C System will then allow business/organizations that are in multi locations around the world the option of offering their membership/loyalty/rewards programs globally rather than country specific. This broadens the range available to the end user/customer and can be particularly good it the end user/customer has to travel abroad for work purposes. For example a gym company which has operations in the United States, United Kingdom and Australia may allow their members to move between gyms in those countries. This opens up a business advantage for those businesses. The end user/customer would just have their barcode/QR code on the smart phone or physical item scanned in at the gym which they were attending. For example if the end user/customer resided in the United States and regularly attended the gym in their home town, however the end user/customer was sent to London in the United Kingdom for work purposes for 4 weeks, and their was a gym of the same company in the London area, then the end user/customer could show their barcode/QR code and work out at the London gym. This would save the end user/customer having to either go without a gym for the period or purchasing a new gym membership.

### Data Upload/Download Control—

In an embodiment of the invention the G4C System allows the end user/customer to make the decision, on how their data is uploaded/downloaded; the current smart phone applications either store data on the phone or on a web database. This causes issues if the end user/customer has a limit to the amount of data upload/download that they can use from their data carrier service. The G4C System can allow the end user/customer to choose if the smart phone:

1/ the data uploads/downloads can occur on demand.
2/ the data uploads/downloads to be scheduled for a particular time and day—this is particularly useful if the end user/customer has older technology in the smart phone, etc.
3/ the data uploads/downloads can occur remotely—i.e. via Bluetooth connection to computer or other digital device; exporting/importing the data to upload/download via a different electronic device, etc.

The end user/customer may have more option selected at a particular time for example if the end user/customer has the data to be scheduled, but going into a business/organization which they want to redeem points or make a purchase, have discounts/offers etc then they can activate an upload/download (i.e. on demand) immediately when going into the business/organization.

### For Businesses/Organizations

### End User/Customer Data

In an embodiment of the invention the G4C System enables businesses to collect end user/customer specific data, it allows for the personalization/customization of what data is collect, the ability to track the end user/customers specific purchases and the products and services that they purchase and are interested in. This currently is not done in memberships/loyalty/reward programs. For example with paper based card there is no ability to track the type of coffee that the customer drinks—i.e. quarter strength latte with a half shot of vanilla on extra hot milk. Therefore without this information businesses are running blind with marketing—for example advertising creamy hot chocolates to an end user/customer who is allergic to chocolate and who has never purchased a hot chocolate from the business. With accurate end user/customer data this enables the business/organization to target market with personalized marketing campaigns. This approach saves the business time and money, and the end user/customer more likely to take notice of the advertising coming form that business if the marketing is meaningful and to the end user/customer's benefit. By accurate reporting of data, businesses will also be able to control stock better, be able to estimate seasonal use of products, etc.

### Accurate and Informative Reporting

In an embodiment of the invention the G4C System allows for accurate and informative reporting. Current systems do not allow for accurate and informative reporting back to the business/organization, for example they do not currently provide the business/organization with a breakdown of the timings of purchase, the location information such as which store location the product was purchased, what items are purchased by the end user/customer. Currently paper based cards only typically only shows the number of units purchased. Whilst current store systems do show the quantity of units purchased and the type of units purchased they do not tie this information back to the end user/customer, i.e. they are not tracking the individual end user/customer spend as typically end user/customers are not on accounts. The G4C System however does track the individual end user/customer spend regardless of the payment method used by the end user/customer; i.e. if the customer uses cash then their purchases are tracked and allowed for each related/unrelated entity to analyze the data.

### Affordability

In an embodiment of the invention is that the G4C System is affordable to small businesses with limited cash flow. Currently it a business wants to participate in a rewards program that is electronic then they would have to invest hundred of thousands and millions of dollars to either participate in an existing system which has little to no features that the G4C System has or alternatively the majority of costs would be taken up with programmers to develop this system. The G4C System is affordable and can be provided to business/organizations very economically with marginal financial investment. The G4C System does not require an organization to pay programmers to customize the system; it is user friendly that does enable a person with a limited skill set for computers to operate.

### Ability to do Meaningful and Target Marketing

In an embodiment of the invention is that the G4C System allows the business/organization to do meaningful and target marketing to their end users/customers. Currently the systems in the market place do not allow for meaningful and target marketing of end users/customers. For example a coffee shop using paper based card, these cards only track the number of drinks that the end user/customer uses and does not track the type or times or location that the customer is purchasing their drinks from. In comparison the G4C System will enable the business/organization to track the type of coffee; where the coffee was purchased, the time of the purchase and frequency of purchase. This allows the business/organization to do personalized meaningful and target marketing to an end user/customer individual or group.

### Ability to Send Urgent Recall Notices

In an embodiment of the invention the G4C System allows for the business/organization to send recall notices, immediately by sms; e-mail, phone call. For example if the supermarket has to recall a product then they advertise that recall in the newspaper typically as they have no details to which end user/customer purchased that product from a specific location and a specific time period. The problem with this current system is that if a customer does not read the newspaper and see the actual advertisement then they are not actually aware of the recall. This means that the information is not getting through to the end user/customer directly affected by the recall. The G4C System has the ability to allow the supermarket to send a text (sms) e-mail or other means such as phone call to the individual who purchased that product from the batch of the product being recalled, based on location and time period information. Never before has a system had the ability for a supermarket to advise the actual end user/customer who has been affected by the recall. This will save the business/organization from the cost of advertising but also ensuring that the information goes to the end user/customer who is directly affected by the recall. The G4C System will also help to mitigate damages as a direct result of loss of life or injury due to the end user/customer not seeing the advertisement in the newspaper,

### Ability to Send Personal Invites to Functions and Fundraisers

In an embodiment of the invention the G4C System allows for the business/organization to better target customers to send out personalized invites to functions and fundraisers. Where the traditional paper based cards are used as most business/organizations don't currently have the ability or means to take the details of their end user/customers then they don't have the ability to send out personalized invitations to functions. For example if a coffee shop was opening a new branch/shop then they could invite all of the end user/customers who lived/worked in the local area of the new coffee shop under the G4C System. The invitation could be send directly to the end user/customers smart phone/computer via sms; email electronic invitation. However under the tradition and current paper based card system this is not possible as they would not know which customer lived where.

### Ability to Better Control Stock

In an embodiment of the invention the G4C System allows for better stock control particularly in businesses that are hard to track. By knowing the end user/customers purchasing habits via product type; location and times this allows the business to plan for possible peaks in certain types of stock—especially seasonal.

Ability to have Better Rewards Targeting

In an embodiment of the invention the G4C System allows the business/organization to have the ability to more accurately target the reward system. For example under the current paper based card system the end user/customer will usually have to get something like drinks before they get a free drink. However if you find that customers are going through the drinks too slowly then the business/organization will have the chance to fine tune the rewards program for their customers. By having the information correctly tracked by the G4C System this allows businesses to better analysis data and also then to enable the business/organization to fire tune their rewards programs and other marketing programs such as offers and discounts.

### Time Saver for Staff

In an embodiment of the invention the G4C System allows for valuable staff resource of time to be more efficiently used in profit making ventures. Under the current system of paper based cards the staff member has to wait until the end user/customer produces their card, and then mark the card such as a signature mark; punch a hole or stamp a stamp to indicate that the end user/customer has purchased an item (such as coffee). This often takes up time that the staff member could put to more efficient use such as service more end users/customers. The G4C System allows for the scanning of the device such as smart phone containing the barcode/QR Code; paper barcode/QR code; PVC card containing the barcode/QR code; and/or any other device. As under the G4C System the end user/customer only has one unique barcode/QR Code this eliminates the need for the end user/customer to go searching amongst many membership/loyalty/rewards cards to find the correct membership/loyalty/rewards card for the business/organization that they are making the purchase at, thus saving time at the counter and time on the part of the erKI user/customer. As the bar code/QR code/or other code via the radio frequency band width is scanned either from the card; smart phone application; paper etc at the point of ordering/purchase is used the time taken by the employee/staff is much less then the time to find a pen to initial; to punch or stamp the current paper based card, thus enabling employees/staff to put their time to more efficient users.

### Less Frustrated Customers

In an embodiment of the invention the G4C System eliminates some of the frustrations of end users/customers, such as:
1. One of the biggest frustration of end users/customers is not being able to find the correct membership/loyalty/rewards card for the business/organization that the end user/customer is making a purchase from and having to spend the time to look for the membership/loyalty/rewards card their wallet/purse just to discover that they have left the membership/loyalty/rewards card at home or at work. The G4C System eliminates this problem by moving the focus from business/organization card specific to the end user/customer specific. Under the G4C System as all the end user/customer only requires a unique barcode/QR code which can be stored in an application on their smart phone, this eliminates the need for the user to look for the business/organization unique card. By the G4C System enabling the end user/customer to have the ability to link multi unrelated/related businesses to the single end user/customer unique barcode/QR code/code it eliminates the need for the end user/customer to carry multiply cards that only relate to individual businesses/organizations or related business/organization groups. If the business/organization has the G4C System implemented and the end user/customer has not registered to the businesses/organization membership/loyalty/rewards program, the end user/customer can immediately Join/register to the membership/loyalty/rewards program on the fly thus eliminating the need to carry multiply cards for multi businesses that are one businesses or business group at a time.
2. Another big frustration for end users/customer is staff time taken to find a pen to sign the loyalty card of the person in front of them at the queue for ordering the product. The G4C system eliminates this waiting by end users/customers for the employee/staff to find a pen; find the hole punch or find the stamp. By simply scanning the barcode/QR code/code on the paper printout; smart phone app; card this is a time saving measure that means that the time to scan is a lot less then the time for staff to find a pen and sign a paper material card. The G4C System allows for the more efficient use of employee/staff time and eliminates the end user/customer frustration of wasted time by employee/staff to find a pen; hole punch; stamp.
3. Not knowing the how the membership/loyalty/rewards programs work is also frustrating for the end user/customer; with the G4C System that information is available in one stop thus saving the end user/customer the time and effort having to go searching on the web or looking for the original membership/loyalty/rewards program information that may have been handed to them on a piece of paper/cardboard.
4. Receiving marketing information from a business/organization which is irrelevant to the individuals interests or wants/needs. With the G4C System the end user/customer is in control of what marketing material they receive from the business/organizations. With the G4C System the marketing material can be personalized to the individual end user/customer and therefore the end user customer can receive marketing material such as discounts and offers that they would be interested in thus eliminating the frustration of having of receiving irrelevant sms messages and email message containing marketing material that the end user/customer has not interest; want or need to know.
5. Recall notices. It is often frustrating to customer that they find out too late that a recall was issued on a product and they were not notified therefore placing them at risk. The G4C System can eliminate this frustration as it allows for the business/organization to provide recall information and advises directly to the effected end user/customer.
6. Not knowing about events put on by businesses/organizations that the end user would be interested in, this frustrates the end user/customer and also makes that end user/customer feel that the business/organization does not value them. With the G4C System this allows for businesses/organizations to issue invitations for events/fundraisers for end user/customers who may not have been invited in the past. The G4C system also ensures that the invitations can be issued to the end user/customer prior to the event being held/run. Thus making the end user/customer feel that they are important to the business and relieving the frustration that the customer did not know of the event or that they received the invitation after the date of the event in the post.
7. One frustration to end user/customers with PVC Cards is not knowing, exactly how many points that they have at any one point and what the points that they have can be redeemed on. With G4C System end users/customers would be able to view online or using the smart phone app and see how many membership/loyalty/rewards units/points/dollars that they have with a particular business. However current systems do not have this ability, currently with the membership/loyalty/rewards systems available the end user/customer has to wait until a statement is issued (typically after the end of the month). When the customer gets the statement usually there is a month lag behind when the points are received to when they show on the statement. With the G4C System that information will be available when the user logs in to the smart phone app or online, there is no waiting until the end of the month. The user will then also be able to see what rewards they can cash in/redeem their units/points/dollars for, and what other prizes are available in the next category up, allowing the user to make an informed decision on what and when to redeem the units/points/dollars for the reward, thus eliminating the frustration of the end user/customer not know how many rewards that they have with the current PVC card system.
8. Another frustration to the end user/customer is not being able to see purchases to check the points have been rewarded against receipts with the current PVC card systems that are available. Often the only thing showing on the paper statement is the amount of units/points/dollars collected for the month and not the amount of points against purchases. This often leads to mistakes of units/points/dollars that should have been issued against a receipt not being issued for the correct amount against the receipt. The current system does not allow for any transparency on the business's part. The end user/customer must take the word of the business that the amount of points showing on the statement is the correct amount. There is no means for the end user/customer to audit/reconcile the units/points/dollars being showed on the statement. There is no way of proving if a business is being deceptive in their conduct with the membership/loyalty/rewards programs. With the G4C System the end user/customer can view via the smart phone app/online how the units/points/dollars are allocated against the purchase of a product. The G4C system show the total units/points/dollars collect to date by the end user/customer per business/organization and it also display a breakdown of those units/points/dollars by purchase by showing information such as date; purchase amount; units/points/dollars earned for the purchase. The G4C system enables the end user/customer to notify the business/organization if they think that there is a discrepancy and therefore the end user/customer has the ability through the G4C System to audit/reconcile the units/points/dollars to what is being viewed on the smart phone app, online G4C System. Thus the G4C System eliminates the end user/customer frustration felt over not being able to see and check, purchases against the units/points/dollars earned.
9. Another frustration to the end user/customer is the amount of paper receipts that are given out by each business. Currently if the end user/customer want to track purchases from walking into multi businesses and making cash purchases, the end user/customer need to keep the paper receipts. In order to conserve space and to prevent the receipts from becoming illegible the end user/customer is forced to scan the paper receipts to keep for tax and record keeping purposes. Another frustration particularly for woman is that paper receipts clog up the hand bag, with men it is wallets bulge from the amount of paper receipts collected. This often leads to the practice of not taking the paper receipt and then finding out later that the end user/customer needed that receipt to return a faulty item or prove proof of purchase. Another paper receipt frustration by the end user/customer is having to wait for a employee/staff member to change a paper roll in the cash register, this takes up the valuable time that the end user/customer can not afford to waste. Another paper receipt frustration by some end user/customer is the environmental effects of having to cut down more trees to produce the paper and having increased green house gases created by the manufacturing process to make paper. The G4C System eliminates these end user/customer frustrations by having the receipt available electronically. This way there a no waiting for employees/staff to change the cash register roll; no issue with carrying around bulky receipts; no issue of double handling the receipt by scanning into electronic form. With the G4C System the receipt can be downloaded and stored electronically on another backup/hard disk device if required or printed or faxed electronically. For example under the G4C System if the end user/customer was to walk into a business to return a good that was faulty, then they could show the employees/staff at the returns desk an electronic receipt via the smart phone app; or via the employees/staff scanning in the barcode/QR code and bringing up the end user/customer's history showing the receipt for that business. This would save the end user/customer arriving at the store minus the paper copy of the receipt or where the paper copy of the receipt had been destroyed/or where the customer was no longer in possession of the paper copy such as burglary. The G4C System would save the business faced with a dilemma of upsetting the customer by refusing to give credit or replacement if no paper receipt was presented; alternatively if the business decided to give credit or replacement even if there was no receipt then this means that the business would pay for the dishonestly of the customer. The G4C System would also stop shop lifting returns, a common problem whereby a dishonest person shop lifts and then tries to return the small items for a business credit to purchase something larger that they are not legally entitled to.

### Less Business Expense

In an embodiment of the invention the G4C System is cost saving to business via the following:
The G4C System gives the ability to the business to be able to personalize marketing; defined target marketing; location target marketing; time target marketing.
The G4C System enables business to save on employee/staff time and therefore costs, as employees/staff are spending less time marking cards via traditional methods of pen marking; hole punching; stamping, etc
The G4C System allows businesses to direct the recall notices saving on potential court case where the end user/customer has been killed or injured due to not seeing a recall notice tucked away in a paper.
The G4C System saves the business/organization on stationery costs, for example costs of cash register rolls as the end user/customer can receive their receipt electronically.
The G4C System gives the business/organization the ability to be on a par with larger companies with membership/loyalty/rewards technology without having to spend hundreds of thousands of dollars to have a software system written for their individual business.

### A Chance b Increase International Exposure

In an embodiment of the invention the G4C System is that it allows businesses to advertise to different markets that they would otherwise have access to; for example a person in Australia could look at the business/organizations in the UK that had implemented the G4C System and be able to directly order off those businesses by immediately Joining that businesses membership/loyalty/rewards program via the smart phone app or online and then the end user/customer's unique barcode/QR Code/Code would immediately be entered by the G4C System into the website of the UK business that the end user/customer was purchasing from. Another benefit under the G4C System is that it would allow for immediate access by tourist coming to the country, for example if a tourist has come to Australia then the tourist would be able to see and join any of the membership/loyalty/rewards programs offered to a business, thus the business/organization has exposure that they may not have had or alternatively they would have had to pay Large advertising sums of money to advertise in media that the tourist would see. International vouchers/discounts are also made possible under the G4C System, for example a two drinks for the price of one voucher allowable in all countries, this means that when the end user/customer travels then they can purchase from businesses/organizations using the vouchers/discounts on their smart phone to buy their favorite coffee from a branch/franchise of the business. That way they could make their purchase whilst being a member of the membership/loyalty/rewards programs, and reap the benefit of that purchase being entitled to a discount/earn point/earn reward dollars, etc.

In some embodiments of the invention, the system and method comprises use of a single loyalty code across a plurality of outlets. The outlets may be of any suitable type in which a loyalty code is useful, for example physical shops, or virtual or online shops or other businesses, clubs, schools, government services, etc.

In some aspects, the invention provides an interface through which a user may select one or more additional loyalty programs to participate in. The system and method of the invention may provide a list stored on a local store, or selection of an option by the user may prompt a search for one or more further loyalty programs which fit one or more criteria. The search may be in a database on a data storage means (such as on a server associated with a system and method of the invention), or it may be on a network of computers, such as the internet.

In some embodiments, the user may be alerted to loyalty programs of interest to that user (for example those which fit one or more preselected criteria). The user may also search, browse or use any other suitable method to identify loyalty programs of interest. In some embodiments, the user may be alerted to or identified (eg. through search) one or more loyalty programs due to one or more social media mechanisms. This may be for any suitable reason, for example because one or more of a user's connections (such as friends or family) are participating in or have shown interest in the loyalty program, or because it is mentioned by a connection, or because other people with one or more similar characteristics have elected to join the loyalty program or shown interest in it etc. Preferably the interface optionally enables the user to join the one or more selected loyalty programs. This may done in any suitable way, for example, the system of the invention may access the API of a system associated with the loyalty program and thereby provide certain data and thereby register the user to that loyalty program. Equally, the system of the invention may simply cause to be displayed a page on a website associated with the loyalty program, or send a message (by sms, email, etc.) eg. to the loyalty program provider or to the user in relation to the loyalty program. Preferably the mechanism for joining an additional loyalty program is quick and simple for the user. For example, it may rely on data previously entered by the user or gathered by the System and Method of the invention in relation to that User in order to apply to join and/or register for the additional loyalty program. In some embodiments, the system and method of the invention allows a single loyalty code to be used for more than one loyalty program.

Embodiments of the invention which comprise the ability to identify and/or sign up to additional loyalty programs allow users to know about other rewards programs and in some embodiments, quickly and easily join them. Once joined the invention may allow a user to have all rewards programs organised in the one place without having to organise those various loyalty programs into folders or other organisational means. This aspect of the invention may in some embodiments, work by using a code to identify the program (i.e. program id code) and then link through to the other rewards program.

In some aspects of the invention loyalty points may be transferred between any two parties, irrespective of any relationship between them. Thus, for example allows the user to transfer points to their best friend to allow their best friend to have a free coffee as well as them. This can be used in any situation where loyalty/reward systems are in place. Transfer may occur by any suitable means, for example, by a simple transfer notification by email, sms, to the recipient or by clicking a button on a web interface.

In some embodiments, loyalty points may be given as a gift to another person. Thus for example, this would allow the user to gift points to their best friend to allow their best friend to take advantage of the earned loyalty rewards, such as for a special occasion, in some embodiments, the system and method of the invention enables a message such as a video message; e-mail; sms; mms or other to be sent with the gift of reward points.

In some embodiments, the system and method of the invention enables a user to loan one or more loyalty points to another person. Such points may be provided free of interest, or interest or some other payment may be required. The system and method of the invention in these embodiments provides an interface for entering the users choices in relation to the person who will be provided with the loan, and terms such as interest etc. in some embodiments, the system and method of the invention provides a user with the ability to request a loan. Such a loan request may be done in any suitable way, for example to a body of users who have agreed to loan points, or to a specific person, etc. In some embodiments, a friend may wish to lend points but wants them returned. This would allow an agreement between the two parties to lend the points and then to have those points paid back when the user who borrowed the points next earns points then they would be automatically assigned to the user who lent the points. Such embodiments solve a common issue for example where a user wishes to purchase something for their children via a rewards program however is for example 5,000 points short.

In some aspects of the invention the system and method enables a user to swap, trade or purchase loyalty points within a market place. As an example, sometimes people accumulate points at a particular business but don't like the rewards offered in return and if those people have the opportunity to swap; trade or purchase points then they may be able to have a reward that they want from a different rewards program. For example, such embodiments are useful in planning events using the reward points.

In some embodiments, the system and method of the invention provides a reward system for a government service such as a transport system or other. In some embodiments the government service allows rewards built up from one or other programs to be redeemed for that particular government service. As an example in relation to the transport system, such an embodiment provides the ability to use a loyalty code and phone id for transport systems rather than having to carry a transport card. Similarly, by providing a reward system for a government service such as a transport system, users may be able to build up points and thereafter travel free from time to time. Such a system and method is preferably utilised using an embodiment of the invention comprising a mobile computing device.

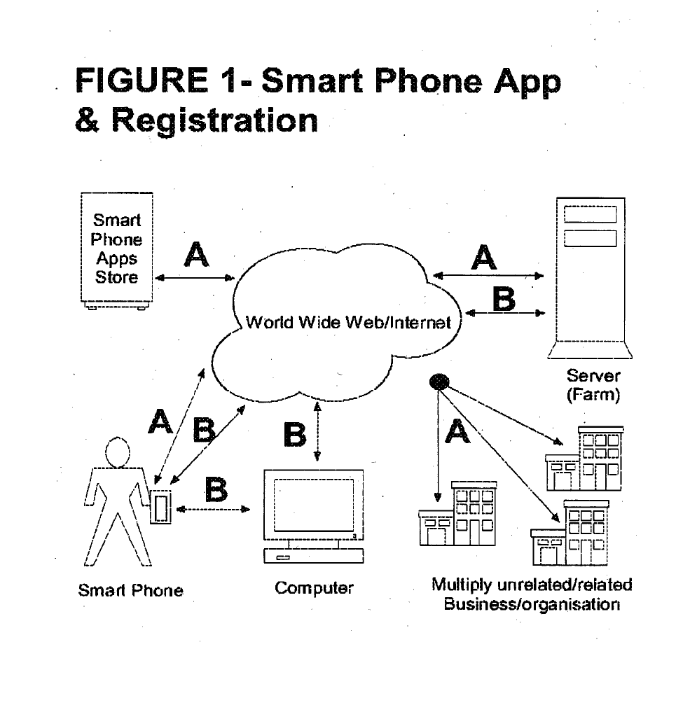

Turning to FIG. 1, the G4C System in accordance with the present invention shows the data flows of:

Purchase/Download Smart phone App. App can be purchased or provided free from App stores; multi unrelated/related business/organizations (as shown in A).

Register device direct from Smart phone; other electronic device; computer where smart phone is connected to computer with G4C System entering required details for example Name; Age; Address etc (as shown in B).
1. Once the registration has been completed unique barcode/QR Code/Code will be provided and the G4C System/Smart Phone App will be updated with that unique barcode/QR Code/Code (as shown in B).
2. Unique barcode/QR Code/Code is now able to be used for purchases once business/organizations has been selected by end user/customer.

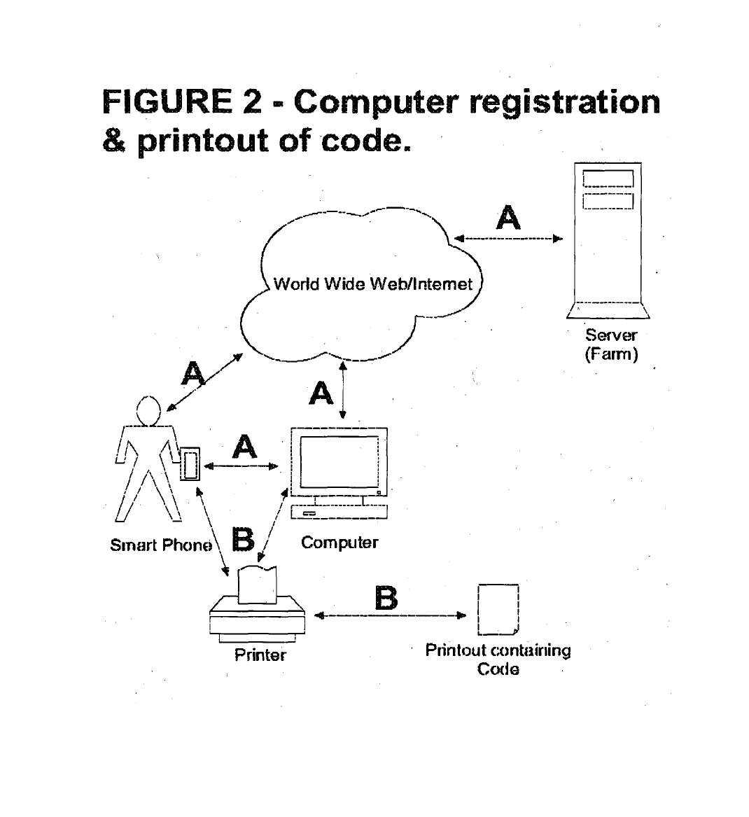

FIG. 2 in accordance with the present invention of the G4C System shows the flow of data of:
1. 1/ Register via World Wide Web/internet with the G4C System entering required details for example Name; Age; Address etc (as shown in A).
2. The G4C System will allocate a unique barcode/QR Code/Code to computer/other electronic device. The end user/customer can select to have the unique barcode/QR Code/Code sent to smart phone/other electronic device (as shown in A).
3. Unique barcode/QR Code/Code is able to be printed out from the computer/smart phone/other electronic device. The printout is able to be used for purchases once business/organizations selected by end user/customer (as shown in B).

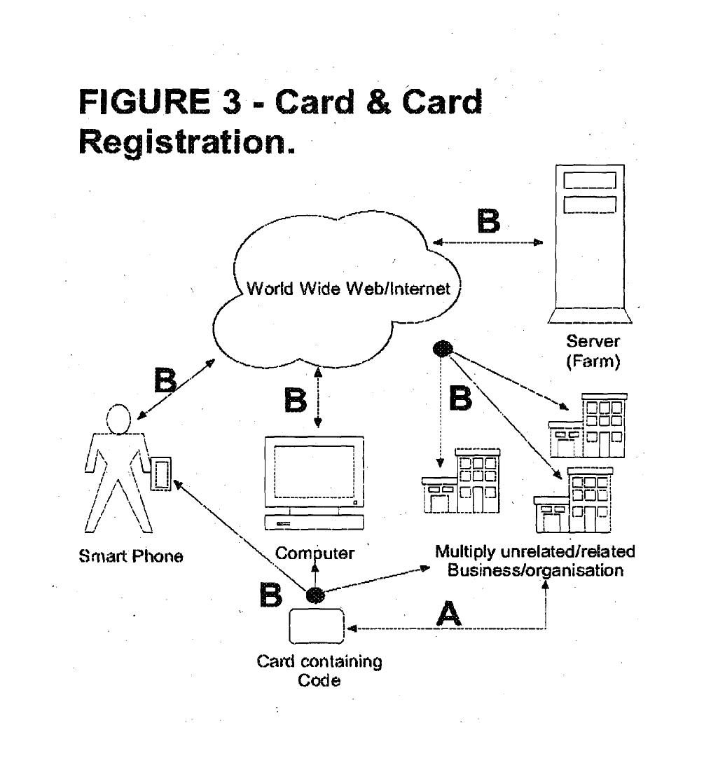

FIG. 3 in accordance with the present invention of the G4C System shows the flow of data of:
1. The end user/customer acquire a Card containing Unique barcode/QR Code/Code from participating business/organization, either by purchasing it or getting it for free (as shown in A).
2. Then the end user/customer will then register the card with the unique barcode/QR Code/Code via Smart Phone; Computer; other electronic device or via the business/organization that supplied the card. By entering into the required registration details for example Name; Age; Address etc (as shown in B).
3. Once the card has been registered with the G4C System then the card is able to be used for purchases once business/organizations selected by the end user/customer.

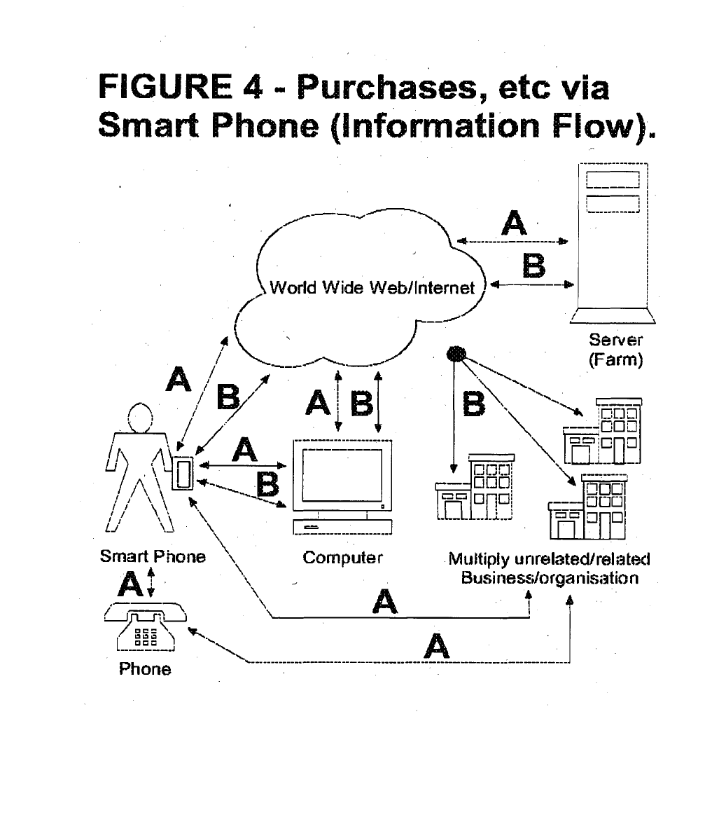

FIG. 4 in accordance with the present invention of the G4C System shows the flow of data of:
1. Enquiry/purchase/lay-buy/service made using smart phone containing barcode/QR code/code at unrelated/related businesses from enquiry/purchase/lay-buy/service by smart phone; enquiry/purchase/lay-buy/service made by computer/other electronic device; enquiry/purchase/lay-buy/service made by non-smart phone & by smart phone used for voice call; enquiry/purchase/lay-buy/service by physically walking into a unrelated/related business & scanning the barcode/QR code/code on the smart phone (as shown in A),
2. Data of the enquiry/purchase/lay-buy/service etc, flows into the G4C System from the unrelated businesses/organization; smart phone & computer; data can flow out of the G4C System back to the unrelated business/organization; smart phone; computer; other electronic device etc (as shown in B).24

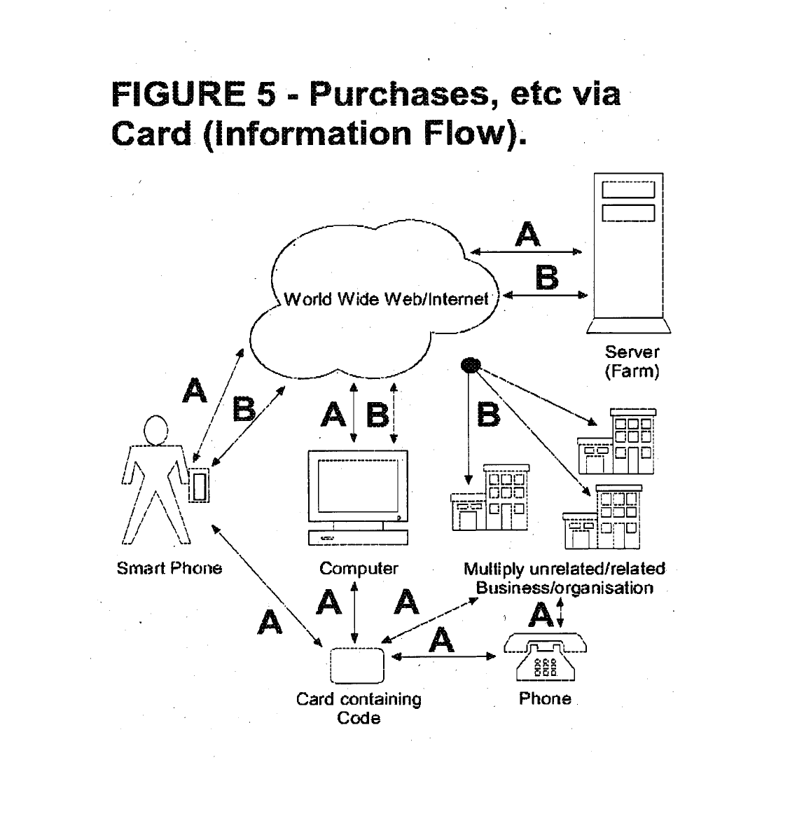

FIG. 5 in accordance with the present invention of the G4C System shows the flow of data of:
1. Enquiry/purchase/lay-buy/service made using card containing barcode/QR code/code at unrelated/related businesses from enquiry/purchase/lay-buy/service by physically walking into a store; enquiry/purchase/lay-buy/service made by smart phone; enquiry/purchase/lay-buy/service made by computer/other electronic device; enquiry/purchase/lay-buy/service made by non-smart phone (as shown in A).
2. Data of the enquiry/purchase/lay-buy/service etc, flows into the G4C System from the unrelated businesses/organization; smart phone & computer; data can flow out of the G4C System back to the unrelated business/organization; smart phone; computer; other electronic device etc (as shown in B).

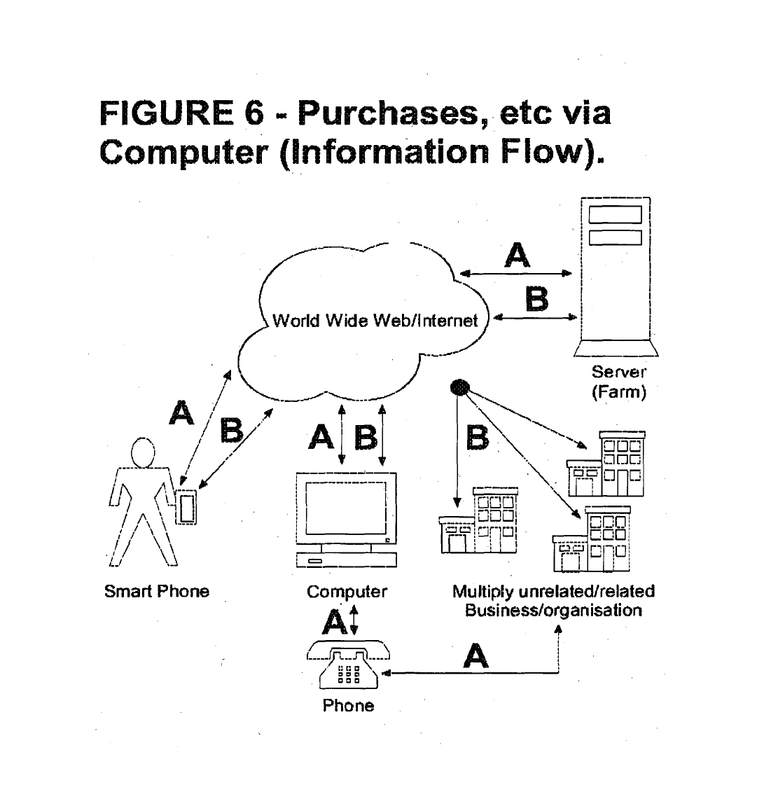

FIG. 6 in accordance with the present invention of the G4C System shows the flow of data of:
1. Enquiry/purchase/lay-buy/service made using computer/other electronic device containing barcode/QR code/code at unrelated/related businesses from enquiry/purchase/lay-buy/service by smart phone; enquiry/purchase/lay-buy/service made by computer/other electronic device; enquiry/purchase/lay-buy/service made by non-smart phone (as shown in A).

1. A system for providing a loyalty reward program comprising a processor to process loyalty program information and a data store to store loyalty program information wherein the system is able to receive instructions directly or indirectly from at least one mobile computing device in order to receive an instruction from a user in relation to the loyalty program, the instruction being operable by the processor to take a step in relation to the loyalty program and wherein the instruction may optionally comprise one or more of (i) adding a user to a database and (ii) recording data in the data store.

2. A loyalty system comprising a mobile computing device and a server wherein the mobile computing device communicates with the server to obtain a loyalty code for use in a loyalty program.

3. A method for providing a loyalty reward program comprising the steps of (a) providing an interface for receiving one or more instructions in relation to a loyalty program, (b) receiving via a network an instruction in relation to a loyalty program, (c) processing the instruction using a processor, and (d) following the instruction(s) which may optionally comprise one or more of (i) adding a user to a database. (ii) recording a loyalty reward event in a data store, and (iii) enable redemption of a loyalty reward.

4. A method for providing a loyalty system comprising a mobile computing device and a server wherein the mobile computing device communicates with the server to obtain a loyalty code for use in a loyalty program.

5. A set of instructions in a machine readable language which are downloadable from a central store onto the mobile computing device and which are for facilitating the use of one or more loyalty codes.

6. A system according to either claim 1 or claim 2 comprising a data store to store and aggregate data relating to purchasing and other behaviours of users of the loyalty scheme.

7. A method according to either claim 3 or claim 4 comprising the step of aggregating data relating to purchasing and other behaviours of users of the loyalty scheme.

8. A system according to either claim 1 or claim 2 in which a single loyalty code may be used across a plurality of unrelated locations.

9. A method according to either claim 3 or claim 4 comprising the step of using a single loyalty code may be used across a plurality of unrelated locations.

10. A system according to either claim 1 or claim 2 comprising a data store to store information relating to a plurality of loyalty programs and an interface to enable a user to search and/or browse information about the one or more loyalty programs and optionally select one or more loyalty programs to join.

11. A method according to either claim 3 or claim 4 comprising the steps of storing in a data store, mrormailon relating to a plurality or loyalty programs and displaying to a user information about the one or more loyalty programs and optionally enabling a user to select one or more loyalty programs to join.
